(19) United States
(12) Patent Application Publication
(10) Pub. No.: US 2026/0338539 A1
(43) Pub. Date: Oct. 29, 2026

(54) APPARATUS AND METHOD FOR CALCULATING HEIGHT OF A BATTERY CELL

(71) Applicant: SK On Co., Ltd., Seoul (KR)

(72) Inventors: Yu Ri SONG, Daejeon (KR); Ung Bae PARK, Daejeon (KR); Byoung Hak LEE, Daejeon (KR); Jung Taek LIM, Daejeon (KR); Young Jin JANG, Daejeon (KR)

(21) Appl. No.: 19/467,799

(22) Filed: Feb. 3, 2026

(30) Foreign Application Priority Data
Feb. 3, 2025 (KR) 10-2025-0012962

(51) Int. Cl. G01B 11/02; G01B 11/06; G06T 7/62; H01M 50/552

(52) U.S. Cl. CPC G01B 11/022; G01B 11/0608; G06T 7/62; H01M 50/552

(57) ABSTRACT

An apparatus for calculating a height of a battery cell according to embodiments of the present disclosure includes: an imager photographing a first surface of a battery cell arranged such that each electrode tab is located at a first end and a second end in a longitudinal direction; an irradiator irradiating light onto the first surface of the battery cell; a measurer located at a first end in a vertical direction perpendicular to the longitudinal direction of the battery cell and measuring a shape of a first side surface of the battery cell on which a first protrusion and a second protrusion are formed; and a controller calculating a height which is a length in a vertical direction of the battery cell.

### CROSS-REFERENCE TO RELATED PATENT APPLICATION

The present application claims priority under 35 U.S.C. § 119(a) to Korean patent application number 10-2025-0012962 filed on Feb. 3, 2025, in the Ministry of Intellectual Property, the entire disclosure of which is incorporated by reference herein.

### BACKGROUND OF THE INVENTION

### 1. Field

The present disclosure relates to an apparatus and method for calculating a height of a battery cell, and to an apparatus and method for calculating a height of a battery cell for accurately calculating a height of a battery cell by considering a length of a protrusion protruding from a pouch of the battery cell.

### 2. Description of the Related Art

An electrode assembly including a positive electrode, a negative electrode, and a separator is enclosed in a case, such that a battery cell is manufactured to have a size that is required for the battery cell to be transported or accommodated in a preset space.

For example, when a plurality of battery cells are stacked in a preset direction with relatively large surfaces facing each other to form a battery assembly, the battery cells need to be manufactured so that the height, which is a length perpendicular to the preset direction of the battery cells, satisfies a preset range, and when the plurality of battery cells are to be accommodated in a preset space, the battery cells need be manufactured to have the height of the battery cells accommodated in the preset space.

On the other hand, a plurality of battery cells manufactured via a manufacturing process may have slightly different heights from each other, so it is necessary to measure the size of the manufactured battery cells to find whether the battery cells are manufactured to have the required size.

For example, in the past, the height of a battery cell has been measured manually using a measuring instrument such as a vernier caliper. However, such manual measurement for the height of the battery cell is relatively time-consuming and expensive to measure the size of the battery cell.

Therefore, it is necessary to develop an apparatus and method for calculating the height of a battery cell, enabling reduction of time and cost required for measuring the height of battery cells by automatically calculating the height of the battery cell.

### SUMMARY OF THE INVENTION

An object of the present disclosure is to provide an apparatus and method for calculating a height of a battery cell, enabling automatic calculation of a height of a battery cell.

Another object of the present disclosure is to provide an apparatus and method for calculating a height of a battery cell, allowing more accurate calculation of a height of a battery cell.

The apparatus and method for calculating a height of a battery cell of the present disclosure may be widely utilized in the field of green technology that involves use of batteries, such as electric vehicles. In addition, battery cells manufactured by the apparatus and method for calculating a height of a battery cell of the present disclosure may be employed in eco-friendly electric vehicles, hybrid vehicles, and the like to prevent climate change by suppressing air pollution and greenhouse gas emissions.

An apparatus for calculating a height of a battery cell according to an embodiment of the present disclosure may include: an imager photographing a first surface of a battery cell arranged such that each electrode tab is located at a first end and a second end in a longitudinal direction; an irradiator irradiating light onto the first surface of the battery cell; a measurer located at a first end in a vertical direction perpendicular to the longitudinal direction of the battery cell and measuring a shape of a first side surface of the battery cell on which a first protrusion and a second protrusion are formed; and a controller calculating, based on information on a shape of the first surface of the battery cell photographed by the imager and information on a shape of the first side surface of the battery cell measured by the measurer, a height which is a length in a vertical direction of the battery cell.

Furthermore, on a second side surface located at the second end in the vertical direction of the battery cell, a bend, in which at least a portion of the second side surface is bent, may be formed, wherein the battery cell may be arranged such that the bend is bent closer to the imager.

Further, the controller may be configured to calculate, based on information on the shape of the first surface of the battery cell, a width, which is the shortest of the lengths between a first end and a second end in a vertical direction of the first surface of the battery cell; to calculate, based on information on the shape of the first side surface of the battery cell, a compensation length, which is a difference between the lengths in a vertical direction of the first protrusion and the second protrusion; and to calculate the height using the width and the compensation length.

In addition, the first protrusion may be located closer to the first surface of the battery cell than the second protrusion, wherein the controller may calculate the height by subtracting the compensation length from the width in the case that the compensation length is negative and calculate the height as being equal to the width in the case that the compensation length is positive.

Furthermore, the imager may include a camera, and the measurer may include a laser scanner.

Furthermore, the controller may control operations of the imager, the irradiator, and the measurer.

A method for calculating a height of a battery cell according to an embodiment of the present disclosure includes: a placing operation for placing a battery cell such that each electrode tab is located at a first end and a second end in a longitudinal direction and a first surface faces an imager; an irradiating operation for irradiating light onto a first surface of the battery cell with an irradiator; a photographing operation for photographing the first surface of the battery cell with the imager; a measuring operation for measuring, using a measurer, a shape of a first side surface of the battery cell, which is located at a first end in a vertical direction perpendicular to a longitudinal direction of the battery cell and on which a first protrusion and a second protrusion are formed; and a calculating operation for calculating, by a controller, a height which is a length in the vertical direction of the battery cell, based on information on a shape of the first surface of the battery cell photographed with the imager and information on a shape of the first side surface of the battery cell measured by the measurer.

Further, on a second side surface located at a second end in the vertical direction of the battery cell, a bend, in which at least a portion of the second side surface is bent, is formed, wherein, in the placing operation, the battery cell is arranged such that the bend is bent closer to the imager.

Further, the calculating operation may include: a first calculating operation for calculating a width, which is the shortest of lengths between a first end and a second end in the vertical direction of the battery cell based on information on a shape of the first surface of the battery cell; a second calculating operation for calculating a compensation length, which is a difference between lengths in a vertical direction of the first protrusion and the second protrusion based on information on a shape of the first side surface of the battery cell; and a third calculating operation for calculating the height using the width and the compensation length.

In addition, the first protrusion may be located closer to the first surface than the second protrusion, wherein, in the third calculating operation, the height may be calculated by subtracting the compensation length from the width in the case that the compensation length is negative, and the height may be calculated as being equal to the width in the case that the compensation length is positive.

Furthermore, the imager may include a camera, and the measurer may include a laser scanner.

Furthermore, the controller may control operations of the imager, the irradiator, and the measurer.

Specific details of other embodiments to solve the problem are included in the detailed description and drawings.

An apparatus and method for calculating a height of a battery cell according to the present disclosure enables a controller to automatically calculate a height of a battery cell based on information on a shape of the battery cell measured with an imager and a measurer.

Furthermore, a height of the battery cell may be calculated more accurately by using a compensation length calculated from lengths of two protrusions formed on a side surface of the battery cell.

### BRIEF DESCRIPTION OF THE DRAWINGS

FIG. 1 is a diagram schematically illustrating an apparatus for calculating a height of a battery cell according to an embodiment of the present disclosure.

FIG. 2 is a diagram illustrating a battery cell.

FIG. 3 is a diagram illustrating a pouch before being bent and bonded.

FIG. 4 is a diagram illustrating a battery cell on which a bend and protrusions are formed.

FIG. 5 is a diagram illustrating a view of photographing, using an imager, a battery cell that is arranged such that a bend is bent away from the imager.

FIG. 6 is a diagram illustrating a view of measuring, using a measurer, a shape of a side surface of a battery cell on which protrusions are formed.

FIG. 7 is a diagram for illustrating a process by which a controller calculates a height of a battery cell based on information on a shape of a first surface of a battery cell photographed by an imager.

FIG. 8 is a diagram illustrating a view of photographing, using an imager, a battery cell having a length of a second protrusion longer than a length of a first protrusion.

FIG. 9 is a diagram for illustrating a process by which a controller calculates a compensation length based on information on a shape of a side surface of a battery cell measured by a measurer.

FIG. 10 is a flowchart illustrating a method for calculating a height of a battery cell according to an embodiment of the present disclosure.

FIG. 11 is a flowchart illustrating a calculating operation.

### DETAILED DESCRIPTION

Hereinafter, embodiments of the present disclosure will be described in detail with reference to the accompanying drawings so that those skilled in the art to which the present application pertains can easily carry out the disclosure. However, the present application may be implemented in various different forms and is not limited to the embodiments described herein. In the drawings, parts irrelevant to the description are omitted for clearly describing the present application, and like reference numerals refer to like elements throughout the specification.

Throughout the specification of the disclosure, when a part is described as being “connected” to another part, it includes not only a case where the part is “directly connected” but also a case where the part is “electrically connected” with another element interposed therebetween.

Throughout the specification of the disclosure, when a member is described as being “on” another member, it includes not only a case where the member is in contact with the other member but also a case where another member is present between the two members.

Throughout the specification of the disclosure, when a part “includes” a component, it means that the part may further include another component unless specifically stated otherwise, rather than excluding the other component. The degree terms such as “about” and “substantially” used throughout the specification of the disclosure are used in a sense close to the numerical value when inherent manufacturing and material tolerances for the stated meaning are presented, and are used to prevent an unscrupulous infringer from unfairly taking advantage of the disclosed content in which precise or absolute numerical values are mentioned for ease of understanding of the present application. The degree terms “~ operation” or “operation of ~” used throughout the specification of the disclosure do not mean “an operation for ~”.

Hereinafter, preferred embodiments of the present disclosure will be described in detail with reference to the accompanying drawings and the content described below. However, the present disclosure is not limited to the embodiments described herein and may be embodied in other forms. Throughout the specification, like reference numerals refer to like components.

Hereinafter, an apparatus for calculating a height of a battery cell according to an embodiment of the present disclosure will be described.

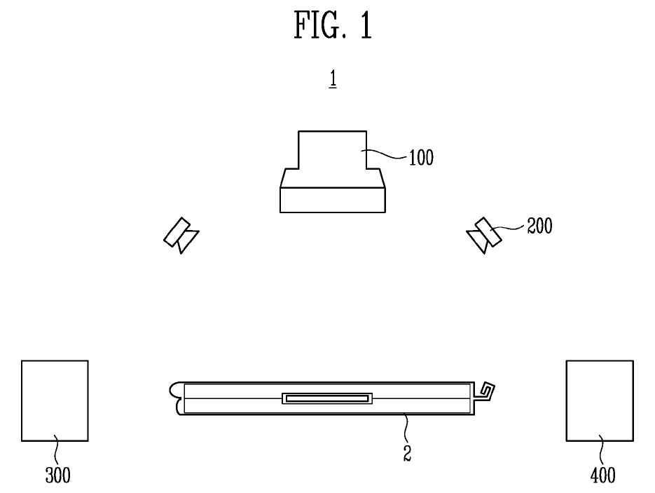

FIG. 1 is a diagram schematically illustrating an apparatus for calculating a height of a battery cell according to an embodiment of the present disclosure.

Referring to FIG. 1, the apparatus for calculating a height of a battery cell 1 includes an imager 100, an irradiator 200, a measurer 300, and a controller 400.

First, the imager 100 will be described.

The imager 100 may photograph a battery cell 2 and include a camera, but the configuration of the imager 100 is not limited thereto.

Specifically, the imager 100 may photograph a first surface of the battery cell 2 that is arranged to have electrode tabs each located at a first end and a second end in a longitudinal direction.

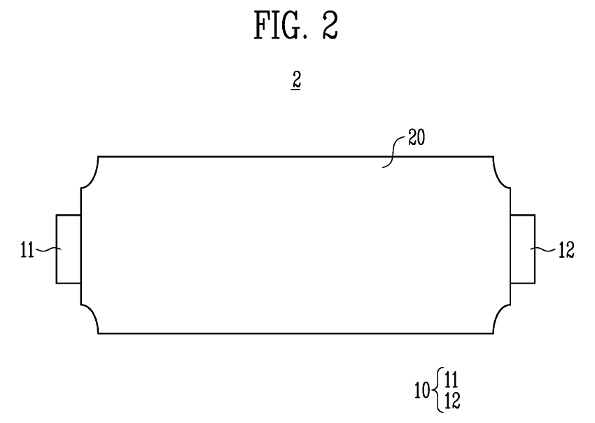

FIG. 2 is a diagram illustrating a battery cell.

Referring to FIG. 2, the battery cell 2 photographed by the imager 100 may be formed to have a first electrode tab 11 arranged at a first end in a longitudinal direction and a second electrode tab 12 arranged at a second end, and may include a pouch 20 that encloses and accommodates an electrode assembly that is electrically coupled to the first electrode tab 11 and the second electrode tab 12.

The electrode assembly may be formed by a plurality of first electrodes and a plurality of second electrodes alternately stacked with a separator interposed in between.

The first electrode may serve as a positive electrode and be formed by applying a first electrode active material, such as a transition metal oxide, to a first electrode current collector formed of a metal foil such as aluminum.

The first electrode may also include a first uncoated electrode, a region to which no first electrode active material is applied, wherein the first uncoated electrode may be a passage for current flow between the first electrode and the outside and may be connected to the first electrode tab 11 or form the first electrode tab 11.

The second electrode may serve as a negative electrode and may be formed by applying a second electrode active material, such as graphite or carbon, to a second electrode current collector formed of a metal foil, such as copper or nickel.

The second electrode includes a second uncoated electrode, a region to which no second electrode active material is applied, wherein the second uncoated electrode may be a passage for current flow between the second electrode and the outside and may be connected to the second electrode tab 12 or form the second electrode tab 12.

The separator is positioned between the first electrode and the second electrode to prevent shorting and to enable the migration of lithium ions. Such a separator may include polyethylene, polypropylene, or a composite film of polyethylene and polypropylene.

The pouch 20 may be formed of an insulating material and bonded by being bent to enclose the electrode assembly, thereby accommodating the electrode assembly therein.

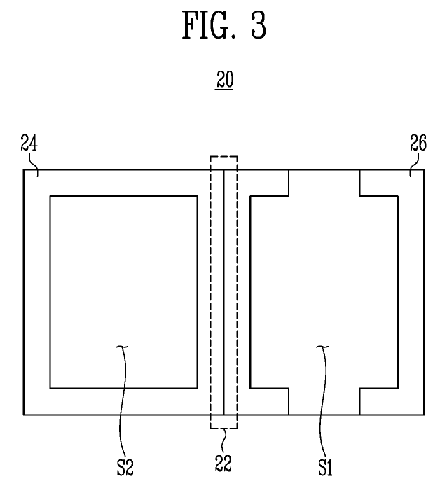

FIG. 3 is a diagram illustrating a pouch before being bent and bonded.

Specifically, with reference to FIG. 3, the pouch 20 may be formed with a first receiving space S1 in which a portion of the electrode assembly is received and a second receiving space S2 in which the remainder of the electrode assembly is received such that the electrode tabs protrude.

In this embodiment, the pouch 20 may enclose the electrode assembly due to a fold 22 being folded as the electrode assembly is placed in the first receiving space S1 or the second receiving space S2, and may be sealed as a first junction 24 and a second junction 26 are bonded.

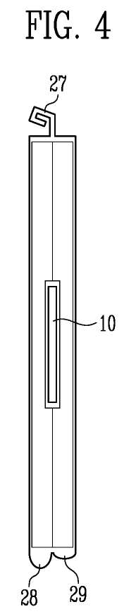

FIG. 4 is a diagram illustrating the battery cell with a bend and protrusions formed.

The pouch 20 accommodating the electrode assembly inside may have a first protrusion 28 and a second protrusion 29 formed in the fold 22, as shown in FIG. 4, and at least a portion of the first junction 24 and second junction 26 that are joined to each other may be bent to form a bend 27.

This bend 27 may be formed to reduce, as much as possible, a length of protrusion of at least a portion of the first junction 24 and second junction 26 that are joined to each other, from an outer circumference of the pouch 20.

In this case, the fold 22 may be formed on a first side surface located at a first end in a vertical direction perpendicular to a longitudinal direction of the battery cell 2, and the bend 27 may be formed on a second side surface located at a second end in a vertical direction of the battery cell 2.

In other words, the first protrusion 28 and the second protrusion 29 may be formed on a first side surface located at a first end in a vertical direction perpendicular to a longitudinal direction of the battery cell 2 to be photographed by the imager 100, and the bend 27 may be formed on a second side surface located at a second end in a vertical direction of the battery cell 2, where at least a portion of the second side surface is bent.

On the other hand, in order to more accurately calculate the height of the battery cell 2, the battery cell 2 may be arranged such that the bend 27 is bent closer to the imager 100, as shown in FIG. 1.

This is because, if the battery cell 2 is arranged to have the bend 27 bent in a direction away from the imager 100, the height of the battery cell 2 may not be accurately calculated.

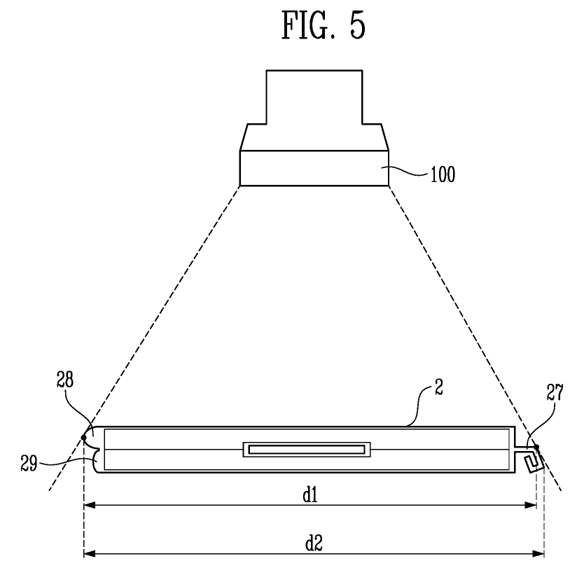

FIG. 5 is a diagram illustrating a view of photographing, using the imager, the battery cell arranged such that the bend is bent in a direction away from the imager.

Specifically, as described with reference to FIG. 5, in the case that the bend 27 of the battery cell 2 being photographed by the imager 100 is bent in a direction away from the imager 100, a length in a vertical direction of the battery cell 2 being photographed by the imager 100 may be a first length d1, but the actual length in a vertical direction of the battery cell 2 may be a second length d2.

In other words, in the case that the bend 27 is bent in a direction away from the imager 100, the width W, which is the length in a vertical direction of the battery cell 2 that is calculated using information on the shape of the first surface of the battery cell 2 photographed by the imager 100, may become different from the height, which is the actual length in a vertical direction of the battery cell 2, because a portion of the bend 27 that protrudes farthest from the battery cell 2 is not photographed by the imager 100.

In contrast, as shown in FIG. 1, in the case that the bend 27 of the battery cell 2 photographed by the imager 100 is bent closer to the imager 100, the width W, which is a length in a vertical direction of the battery cell 2 that is calculated by including information on the shape of the second side surface of the battery cell 2 photographed by the imager 100, may become the same as the height, which is the length in a vertical direction of the actual battery cell 2 because the portion of the bend 27 that protrudes farthest from the battery cell 2 is photographed by the imager 100.

On the other hand, information on the shape of first surface of the battery cell 2 photographed by the imager 100 may be transmitted to the controller 400 to be described later.

By way of example, the imager 100 may be configured to transmit and receive information wiredly or wirelessly to and from the controller 400 to transmit information on the shape of the first surface of the battery cell 2 photographed to the controller 400.

Next, the irradiator 200 will be described.

The irradiator 200 may irradiate the first surface of the battery cell 2 with light.

Specifically, the irradiator 200 may include a lamp or the like that irradiates light onto a first surface of the battery cell 2 so that the imager 100 may accurately photograph the first surface of the battery cell 2, and at least one of the lamps may be disposed in a direction opposite to the first surface of the battery cell 2 to irradiate light onto the first surface of the battery cell 2 such that the first surface of the battery cell 2 is effectively irradiated.

By way of example, as illustrated in FIG. 1, the irradiator 200 may be formed as a lamp capable of irradiating light, and may be configured to irradiate light onto the first surface of the battery cell 2 by having a plurality of lamps symmetrically arranged in a direction opposite to the first surface of the battery cell 2 with respect to the imager 100, but the configuration of the irradiator 200 is not limited thereto.

Next, the measurer 300 will be described.

The measurer 300 may measure the shape of the first side surface.

That is, the measurer 300 may be located at the first end in a vertical direction perpendicular to the longitudinal direction of the battery cell 2, and may measure the shape of the first side surface of the battery cell 2 on which the first protrusion 28 and the second protrusion 29 are formed.

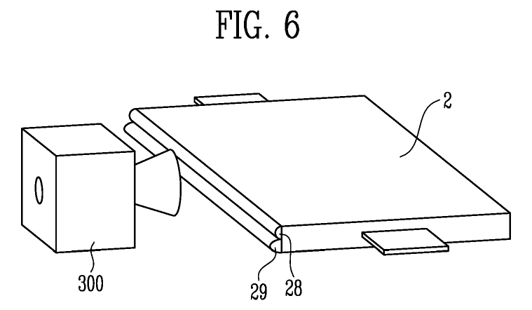

FIG. 6 is a diagram illustrating a view of measuring, using the measurer, the shape of a side surface of the battery cell on which protrusions are formed.

By way of example, the measurer 300 may include a laser scanner capable of measuring the shape of a certain object by scanning a surface of the certain object while moving, and as shown in FIG. 6, may measure the shape of the first side surface of the battery cell 2 by scanning the first side surface of the battery cell 2 while moving.

As such, information on the shape of the first side surface of the battery cell 2 measured by the measurer 300 may be transmitted to the controller 400.

By way of example, the measurer 300 may be configured to wiredly or wirelessly transmit and receive information to and from the controller 400 to transmit information on the photographed shape of the first surface of the battery cell 2 to the controller 400.

The controller 400 will now be described.

The controller 400 may control operations of the imager 100, the irradiator 200, and the measurer 300.

In addition, the controller 400 may include a computer capable of receiving information on the shape of a certain object and calculating the length of the shape of the certain object based on the received information, and may calculate the height of the battery cell 2 based on the information received from the imager 100 and the information received from the measurer 300.

That is, the controller 400 may calculate a height, which is a length in a vertical direction of the battery cell 2, based on information on a shape of a first surface of the battery cell 2 photographed by the imager 100 and information on a shape of a first side surface of the battery cell 2 measured by the measurer 300.

Specifically, the controller 400 may calculate a width W, which is the shortest length of those between a first end and a second end in a vertical direction of the first surface of the battery cell 2 based on information on the shape of the first surface of the battery cell 2.

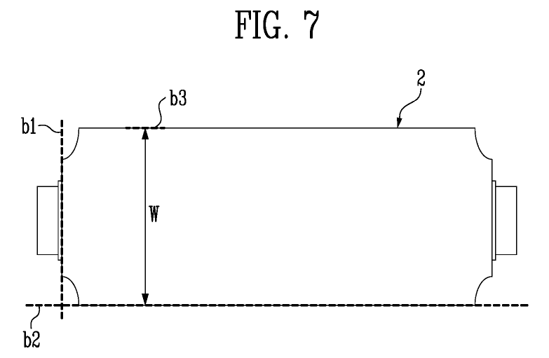

FIG. 7 is a diagram for illustrating a process by which the controller calculates a height of the battery cell based on information on the shape of a first surface of the battery cell photographed by the imager.

For example, as described with reference to FIG. 7, the controller 400 may first establish a first boundary b1 in a vertical direction between any one of the electrode tabs 10 and the pouch 20 based on information on the shape of the first surface of the battery cell 2.

Then, the controller 400 may set a second boundary b2 formed by a first side surface or a second side surface.

Next, the controller 400 may set a third boundary b3 on a portion of the first side surface or the second side surface located at a position spaced a preset distance in a longitudinal direction from the first boundary b1.

In this case, if the second boundary b2 is formed on the first side surface, the third boundary b3 is set on a portion of the second side surface, and if the second boundary b2 is formed on the second side surface, the third boundary b3 is set on the first side surface.

Finally, the controller 400 may calculate the shortest of the distances between the second boundary b2 and the third boundary b3 to calculate a width W of the battery cell 2.

On the other hand, the configuration in which the controller as described in FIG. 7 calculates the width W of the battery cell 2 is a configuration for calculating the width W of the battery cell 2 according to an example, and the controller 400 may calculate the width W of the battery cell 2 in various other ways.

Furthermore, the width W of the battery cell 2 calculated by the controller 400 may differ from the height, which is the length in a vertical direction of the actual battery cell 2, because it is calculated only based on information on the shape of the first surface of the battery cell 2 photographed with the imager 100.

In other words, the width W of the battery cell 2 calculated based on the information on the shape of the first surface of the battery cell 2 photographed by the imager 100 may have a different value from the height of the battery cell 2 depending on the shape of the first protrusion 28 and the second protrusion 29 formed on the first side surface of the battery cell 2.

Therefore, in order to more accurately calculate the height of the battery cell 2, it is necessary to take into account not only the width W of the battery cell 2, but also information on the shape of the first protrusion 28 and the second protrusion 29 formed on the first side surface of the battery cell 2.

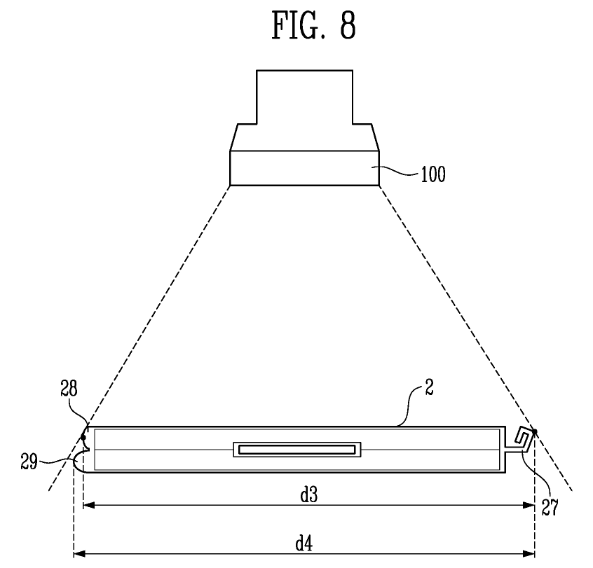

FIG. 8 is a diagram illustrating a view of photographing, using an imager, the battery cell of which a length of the second protrusion is longer than that of the first protrusion.

Specifically, as described with reference to FIG. 8, when the length in a vertical direction of the second protrusion 29 is longer than the length in a vertical direction of the first protrusion 28, the length in a vertical direction of the battery cell 2 photographed by the imager 100 is a third length d3, but the actual length in a vertical direction of the battery cell 2 may be a fourth length d4.

In other words, if the length in a vertical direction of the second protrusion 29 is longer than the length in a vertical direction of the first protrusion 28, but the second protrusion 29 is not photographed by the imager 100, the width W, which is the length in a vertical direction of the battery cell 2 that is calculated using information on the shape of the first surface of the battery cell 2 photographed by the imager 100, may become different from the height, which is the actual length in a vertical direction of the battery cell 2.

To address this issue, the height of the battery cell 2 may be calculated by adding or subtracting a compensation length calculated based on information on the shape of the first protrusion 28 and the second protrusion 29 from the width W of the battery cell 2 calculated by the controller 400.

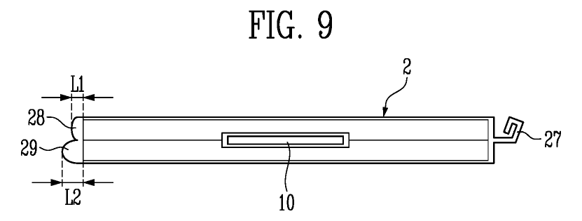

FIG. 9 is a diagram for illustrating a process in which the controller calculates a compensation length based on information on the shape of a side surface of the battery cell measured by the measurer.

Specifically, as described with reference to FIG. 9, the first protrusion 28 may be located closer to a first surface of the battery cell 2 than the second protrusion 29. In other words, the second protrusion 29 may be located farther from the imager 100 than the first protrusion 28.

In this case, the controller 400 may calculate a compensation length, which is a difference between the lengths in a vertical direction of the first protrusion 28 and the second protrusion 29, based on information on the shape of the first side surface as measured by the measurer 300.

By way of example, the controller 400 may calculate a first protrusion length L1 in which the first protrusion 28 protrudes from a certain portion of the battery cell 2 and a second protrusion length L2 in which the second protrusion 29 protrudes from a certain portion of the battery cell 2.

The controller 400 may then calculate a compensation length by subtracting the second protrusion length L2 from the first protrusion length L1.

The controller 400 may utilize the calculated width W of the battery cell 2 and the compensation length of the battery cell 2 to calculate the height of the battery cell 2.

Specifically, the controller 400 may calculate the height of the battery cell 2 by subtracting the compensation length of the battery cell 2 from the width W of the battery cell 2 if the compensation length of the battery cell 2 is negative, and may calculate the height of the battery cell 2 as being equal to the width W of the battery cell 2 if the compensation length of the battery cell 2 is positive.

In other words, if the compensation length of the battery cell 2 is negative, the length in a vertical direction of the second protrusion 29 is longer than the length in a vertical direction of the first protrusion 28, such that the length in a vertical direction of the second protrusion 29, which is not photographed by the imager 100 and thus is not considered in calculation of the width W of the battery cell 2, may be added to the width W of the battery cell 2 to obtain the height of the battery cell 2.

And, if the compensation length of the battery cell 2 is positive, the length in a vertical direction of the first protrusion 28 is longer than the length in a vertical direction of the second protrusion 29, such that the height of the battery cell 2 may be calculated as being equal to the width W of the battery cell 2 by determining that there is no length in a vertical direction of the second protrusion 29 that was not considered when calculating the width W of the battery cell 2.

Hereinafter, a method for calculating a height of a battery cell according to an embodiment of the present disclosure will be described.

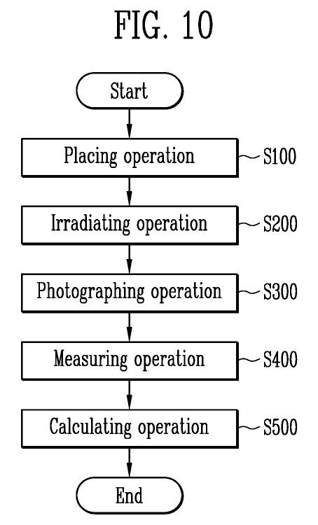

FIG. 10 is a flowchart illustrating the method for calculating a height of a battery cell according to an embodiment of the present disclosure.

Referring to FIG. 10, the method for calculating a height of a battery cell according to an embodiment of the present disclosure includes a placing operation S100, an irradiating operation S200, a photographing operation S300, a measuring operation S400, and a calculating operation S500.

The placing operation S100 is a process of placing a battery cell 2 to have electrode tabs 11, 12 each located at a first end and a second end in a longitudinal direction, while a first surface facing the imager 100.

The specific configuration of the battery cell 2 and the specific configuration of the imager 100 are the same as the configuration of the battery cell 2 and the configuration of the imager 100 described above in the apparatus for calculating a height of a battery cell 1.

In other words, on a second side surface located at a second end in a vertical direction of the battery cell 2, a bend 27, in which at least a portion of the second side surface is bent, is formed, and in the placing operation S100, the battery cell 2 may be placed such that the bend 27 is bent closer to the imager 100.

Next, the irradiating operation S200 will be described.

The irradiating operation S200 is a process in which light is irradiated onto a first surface of the battery cell 2 with the irradiator 200.

The specific configuration of the irradiator 200 is the same as the configuration of the irradiator 200 described above in the apparatus for calculating a height of a battery cell 1.

Next, the photographing operation S300 will be described.

The photographing operation S300 is a process in which a first surface of the battery cell 2 is photographed with the imager 100.

The information on the shape of the first surface of the battery cell 2 photographed by the imager 100 may be transmitted to the controller 400, and the specific configuration in which the information on the shape of the first surface of the battery cell 2 is transmitted to the controller 400 is the same as the configuration in which the information on the shape of the first surface of the battery cell 2 is transmitted to the controller 400 as described above in the apparatus for calculating a height of a battery cell 1.

Next, the measuring operation S400 will be described.

The measuring operation S400 is a process in which the measurer 300 measures the shape of the first side surface of the battery cell 2, which is located at a first end in a vertical direction perpendicular to a longitudinal direction of the battery cell 2 and in which the first protrusion 28 and the second protrusion 29 are formed.

The specific configuration of the measurer 300 is the same as the configuration of the measurer 300 as described above in the apparatus for calculating a height of a battery cell 1.

Next, the calculating operation S500 will be described.

The calculating operation S500 is a process in which the controller 400 calculates a height, which is a length in a vertical direction of the battery cell 2, based on information on the shape of a first surface of the battery cell 2 photographed by the imager 100 and information on the shape of the first side surface of the battery cell 2 measured by the measurer 300.

In this case, the specific configuration of the controller 400 is the same as the configuration of the controller 400 as described above in the apparatus for calculating a height of a battery cell 1.

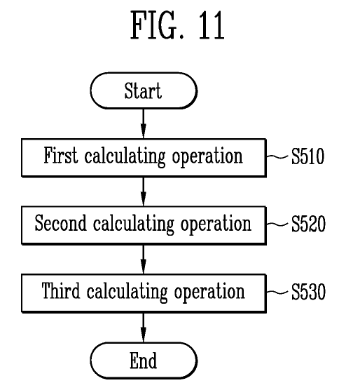

FIG. 11 is a flowchart illustrating a calculating operation.

And, as shown in FIG. 11, the calculating operation S500 may include a first calculating operation S510, a second calculating operation S520, and a third calculating operation S530.

The first calculating operation S510 is a process of calculating a width W, which is the shortest of the lengths between a first end and a second end in a vertical direction of the battery cell 2, based on information on the shape of the first surface of the battery cell 2.

The specific configuration of the first calculating operation S510 is the same as the configuration in which the controller 400 as described above in the apparatus for calculating a height of a battery cell 1 calculates the width W of the battery cell 2.

The second calculating operation S520 is a process of calculating a compensation length, which is a difference between the lengths in a vertical direction of the first protrusion 28 and the second protrusion 29, based on information on the shape of the first side surface of the battery cell 2.

The specific configuration of the second calculating operation S520 is the same as the configuration in which the controller 400 as described above in the apparatus for calculating a height of a battery cell 1 calculates the compensation length of the battery cell 2.

The third calculating operation S530 is a process of calculating the height of the battery cell 2 using the width W of the battery cell 2 and the compensation length.

The specific configuration of the third calculating operation S530 is the same as the configuration in which the controller 400 as described above in the apparatus for calculating a height of a battery cell 1 calculates the height of the battery cell 2.

In other words, the first protrusion 28 may be located closer to a first surface than the second protrusion 29, and in the third calculating operation S530, the height of the battery cell 2 is calculated by subtracting the compensation length from the width W of the battery cell 2 when the compensation length is negative, and the height of the battery cell 2 may be calculated to be equal to the width W of the battery cell 2 when the compensation length is positive.

Thus, the apparatus and method for calculating a height of a battery cell according to the present disclosure provides an effect that the height of the battery cell may be calculated automatically, since the controller is configured to calculate the height of the battery cell based on information on the shape of the battery cell measured using the imager and the measurer.

Furthermore, the configuration, in which the height of the battery cell is calculated using a compensation length calculated from the lengths of two protrusions formed on the side surfaces of the battery cell, provides the effect that the height of the battery cell is calculated more accurately.

The above description of the present disclosure is merely for illustrative purposes, and those skilled in the art to which the present disclosure pertains will understand that various modifications can be easily made without departing from the technical spirit or essential features of the present disclosure. Therefore, the embodiments described above are to be understood as illustrative and not restrictive in all respects. For example, each component described as being in a single form may be implemented in a dispersed form, and components described as being dispersed may likewise be implemented in a combined form.

The scope of this disclosure is indicated by the following claims rather than by the detailed description above, and the meaning and scope of the claims and all modifications or variations derived from the equivalents thereof are to be construed as being within the scope of this disclosure.

What is claimed is:

1. An apparatus for calculating a height of a battery cell, comprising:
an imager photographing a first surface of a battery cell arranged such that each electrode tab is located at a first end and a second end in a longitudinal direction;
an irradiator irradiating light onto the first surface of the battery cell;
a measurer located at a first end in a vertical direction perpendicular to the longitudinal direction of the battery cell and measuring a shape of a first side surface of the battery cell on which a first protrusion and a second protrusion are formed; and
a controller calculating, based on information on a shape of the first surface of the battery cell photographed by the imager and information on a shape of the first side surface of the battery cell measured by the measurer, a height which is a length in a vertical direction of the battery cell.

2. The apparatus for calculating a height of a battery cell according to claim 1, wherein, on a second side surface located at the second end in the vertical direction of the battery cell, a bend, in which at least a portion of the second side surface is bent, is formed,
wherein the battery cell is arranged such that the bend is bent closer to the imager.

3. The apparatus for calculating a height of a battery cell according to claim 2, wherein the controller is configured:
to calculate, based on information on the shape of the first surface of the battery cell, a width, which is the shortest of the lengths between a first end and a second end in a vertical direction of the first surface of the battery cell;
to calculate, based on information on the shape of the first side surface of the battery cell, a compensation length, which is a difference between the lengths in a vertical direction of the first protrusion and the second protrusion; and
to calculate the height using the width and the compensation length.

4. The apparatus for calculating a height of a battery cell according to claim 3, wherein the first protrusion is located closer to the first surface of the battery cell than the second protrusion,
wherein the controller calculates the height by subtracting the compensation length from the width in the case that the compensation length is negative and calculates the height as being equal to the width in the case that the compensation length is positive.

5. The apparatus for calculating a height of a battery cell according to claim 4, wherein the imager includes a camera, and
the measurer includes a laser scanner.

6. The apparatus for calculating a height of a battery cell according to claim 1, wherein the controller controls operations of the imager, the irradiator, and the measurer.

7. A method for calculating a height of a battery cell, the method comprising:
a placing operation for placing a battery cell such that each electrode tab is located at a first end and a second end in a longitudinal direction and a first surface faces an imager;
an irradiating operation for irradiating light onto a first surface of the battery cell with an irradiator;
a photographing operation for photographing the first surface of the battery cell with the imager;
a measuring operation for measuring, using a measurer, a shape of a first side surface of the battery cell, which is located at a first end in a vertical direction perpendicular to a longitudinal direction of the battery cell and on which a first protrusion and a second protrusion are formed; and
a calculating operation for calculating, using a controller, a height which is a length in the vertical direction of the battery cell, based on information on a shape of the first surface of the battery cell photographed with the imager and information on a shape of the first side surface of the battery cell measured by the measurer.

8. The method for calculating a height of a battery cell according to claim 7, wherein, on a second side surface located at a second end in the vertical direction of the battery cell, a bend, in which at least a portion of the second side surface is bent, is formed,
wherein, in the placing operation, the battery cell is arranged such that the bend is bent closer to the imager.

9. The method for calculating a height of a battery cell according to claim 8, wherein the calculating operation comprises:
a first calculating operation for calculating a width, which is the shortest of lengths between a first end and a second end in the vertical direction of the battery cell based on information on a shape of the first surface of the battery cell;
a second calculating operation for calculating a compensation length, which is a difference between lengths in a vertical direction of the first protrusion and the second protrusion based on information on a shape of the first side surface of the battery cell; and
a third calculating operation for calculating the height using the width and the compensation length.

10. The method for calculating a height of a battery cell according to claim 9, wherein the first protrusion is located closer to the first surface than the second protrusion,
wherein, in the third calculating operation, the height is calculated by subtracting the compensation length from the width in the case that the compensation length is negative, and the height is calculated as being equal to the width in the case that the compensation length is positive.

11. The method for calculating a height of a battery cell according to claim 10, wherein the imager includes a camera, and
the measurer includes a laser scanner.

12. The method for calculating a height of a battery cell according to claim 7, wherein the controller controls operations of the imager, the irradiator, and the measurer.
